(19) United States
(12) Patent Application Publication
(10) Pub. No.: US 2010/0088628 A1
(43) Pub. Date: Apr. 8, 2010

(54) LIVE PREVIEW OF OPEN WINDOWS

(75) Inventors: Anders FLYGH, Malmo (SE); Patrik VIKNER, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/246,675

(22) Filed: Oct. 7, 2008

(51) Int. Cl. G06F 3/048

(52) U.S. Cl. 715/779

(57) ABSTRACT

A method may be performed by a device having a display and multiple open applications. The method may include displaying a toolbar on a portion of the display, the toolbar including a menu of items, where each item corresponds to an open application window associated with one of the open applications. The method may also include receiving selection of one of the items on the menu and identifying an open application window corresponding to the selected one of the items. The method may further include altering the display to show, behind the toolbar, the identified open application window.

### BACKGROUND

Devices, such as mobile communication devices (e.g., cell phones, personal digital assistants (PDAs), etc.), include some kind of display to provide a user with visual information. These devices may also include touch sensitive input devices (e.g., touch sensitive interfaces or displays). A growing variety of applications and capabilities for handheld devices continues to drive a need for improved interfaces for these devices.

### SUMMARY

According to one implementation, a method may be performed by a device having a display and multiple open applications. The method may include displaying a toolbar on a portion of the display, the toolbar including a menu of items, where each item corresponds to an open application window associated with one of the open applications; receiving selection of one of the items on the menu; identifying an open application window corresponding to the selected one of the items; and altering the display to show, behind the toolbar, the identified open application window.

Additionally, receiving the selection may include receiving a touch on a touch panel.

Additionally, receiving the selection may further include identifying touch coordinates of the touch on the touch panel, and associating the touch coordinates with the one of the items on the menu.

Additionally, at least a portion of the toolbar may be partially transparent.

Additionally, the toolbar may be smaller than a size of the identified open application window.

Additionally, the method may include receiving selection of another one of the items on the menu; identifying another open application window associated with a same one of the open applications or a different one of the open applications; and altering the display to show, behind the toolbar, the other open application window.

Additionally, the method may include identifying a user selection of one of the items on the menu; and removing the display of the toolbar from on top of the identified open application in response to the identified user selection.

Additionally, identifying the user selection may include identifying no touch coordinates corresponding to a touch on the toolbar.

Additionally, the method may include receiving a signal to activate the toolbar, where the signal is generated by one of: pressing a control button on the device, touching a particular location of a touch panel on the device that is designated to activate the toolbar, dragging an icon from another portion of display onto an open window, or providing a voice command.

According to another implementation, a device may include a display to present a toolbar and one of multiple open application windows, the toolbar including a list of the multiple open application windows; a touch panel to identify coordinates of a touch on the touch panel; and a processor. The processor may associate the touch coordinates with one of the multiple open application windows on the list, identify an open application window associated with the one of the multiple open application windows on the list, and alter the display to show the one of the multiple open application windows behind the toolbar.

Additionally, the device may include a memory to store data that supports the displaying and updating of the multiple open application windows.

Additionally, at least a portion of the toolbar may be partially transparent.

Additionally, the toolbar may be smaller than a size of the one of the multiple open application windows.

Additionally, the processor may be further configured to identify a removal of the touch from the touch panel and remove, based on the identified removal, the display of the toolbar from on top of the one of the multiple open application windows.

Additionally, the touch panel may be overlaid on the display.

Additionally, the device may include a housing, where the touch panel and the display are located on separate portions of the housing.

Additionally, the processor may be further configured to activate displaying of the toolbar based on a touch on a particular location of the touch panel.

According to yet another implementation, a device may include means for displaying a toolbar and one of multiple open application windows, the toolbar including a menu of items, where each of the items corresponds to one of the multiple open application windows; means for identifying one of the items on the menu; means for identifying one of the multiple open application windows corresponding to the identified one of the items; and means for displaying, behind the toolbar, the identified one of the multiple open application windows.

Additionally, the device may include means for activating displaying of the toolbar and means for removing the toolbar.

Additionally, the device may include means for identifying a different one of the items on the menu; means for identifying another one of the multiple open application windows corresponding to the different one of the items; and means for displaying, behind the toolbar, the other one of the multiple open application windows.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is a schematic illustrating an exemplary implementation of the concepts described herein;

FIG. 2 depicts an exemplary diagram of a user device in which systems and/or methods described herein may be implemented;

FIG. 3 illustrates a diagram of exemplary components of the user device depicted in FIG. 1;

FIG. 4 is functional block diagram of the user device of FIG. 3;

FIG. 5 is a diagram illustrating exemplary touch sequences on the surface of an exemplary user device;

FIG. 6 shows an exemplary touch input on the surface of a display as a function of time according to an exemplary implementation;

FIG. 7 illustrates a flow chart of an exemplary process for operating the user device depicted in FIG. 1 according to implementations described herein; and

FIG. 8 is an isometric view of another exemplary user device in which methods and systems described herein may be implemented.

### DETAILED DESCRIPTION

The following detailed description refers to the accompanying drawings. The same reference numbers in different drawings may identify the same or similar elements. Also, the following detailed description does not limit the invention.

### OVERVIEW

Systems and/or methods described herein may provide a user with an easy way to preview open browser windows and other application windows from a toolbar in a user device. A user may toggle between windows in accordance with a highlighted item on a menu list on the toolbar and be able to see, behind the toolbar, a live preview of the open application window corresponding to the highlighted menu item.

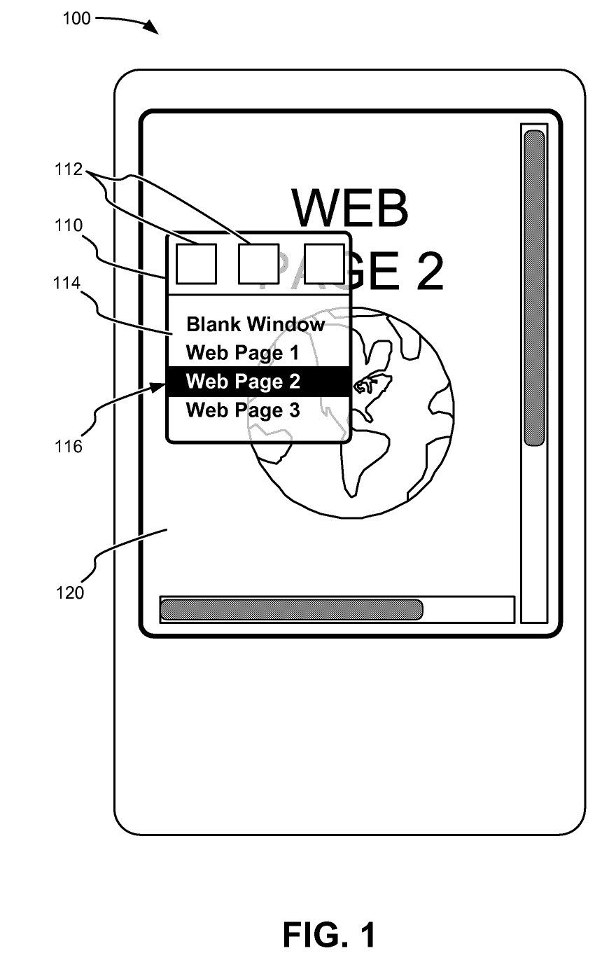

FIG. 1 provides a schematic illustrating an exemplary implementation of the concepts described herein. Referring to FIG. 1, a user device 100 may display a toolbar 110 and a live preview of an open application window 120 behind toolbar 110. Toolbar 110 may include one or more command icons 112 and an open application menu 114. Command icons 112 may generally provide options to alter the display (e.g., zoom commands) and/or navigate among open applications operating in device 100. Toolbar 110 may provide a user interface to allow a user to see the display of an open application window when selecting an item from the open application menu 114. Each item in open application menu 114 may be generated based on an identifier of each open application window (or particular categories of open application windows) currently running in user device 100. Thus, in FIG. 1, a user indication 116 of “Web Page 2” may trigger user device 100 to display the open application window 120 that corresponds to user indication 116. The user may browse through multiple other open application windows (e.g., “Blank Window”, “Web Page 1,” and “Web Page 3”) by indicating the corresponding item on open application menu 114. When another item on open application menu 114 is indicated, user device 100 can display the open application window that corresponds to the indicated item.

In one implementation, toolbar 110 may be of a size smaller than the open application window 120 to allow the user to perceive the contents of open application window 120. In another implementation, some or all of toolbar 110 may be partially transparent to allow at least a portion of open application window 120 to be seen through toolbar 110.

A “user device,” as the term is used herein, is intended to be broadly interpreted to include a mobile communication device (e.g., a radiotelephone, a personal communications system (PCS) terminal that may combine a cellular radiotelephone with data processing, a facsimile, and data communications capabilities, a personal digital assistant (PDA) that can include a radiotelephone, pager, Internet/intranet access, web browser, organizer, camera, a Doppler receiver, and/or global positioning system (GPS) receiver, a GPS device, a telephone, a cellular phone, etc.); a laptop computer; a personal computer; a printer; a facsimile machine; a pager; a camera (e.g., a contemporary camera or a digital camera); a video camera (e.g., a camcorder); a gaming device; and/or any other device capable of utilizing a touch screen display.

The term “user,” as used herein, is intended to be broadly interpreted to include a user device or a user of a user device.

An “open application window,” as used herein, may be broadly interpreted to include a visual area associated with an instance of a program or application being run on a user device. For example, one open application window may include a web page presented within a web browser, while a second open application window may include another web page presented within the web browser. As another example, an open application window may include a user interface associated with an application, such as a spreadsheet, while a second open application window may include a user interface associated with another application, such as an image-viewing application.

### Exemplary User Device Configuration

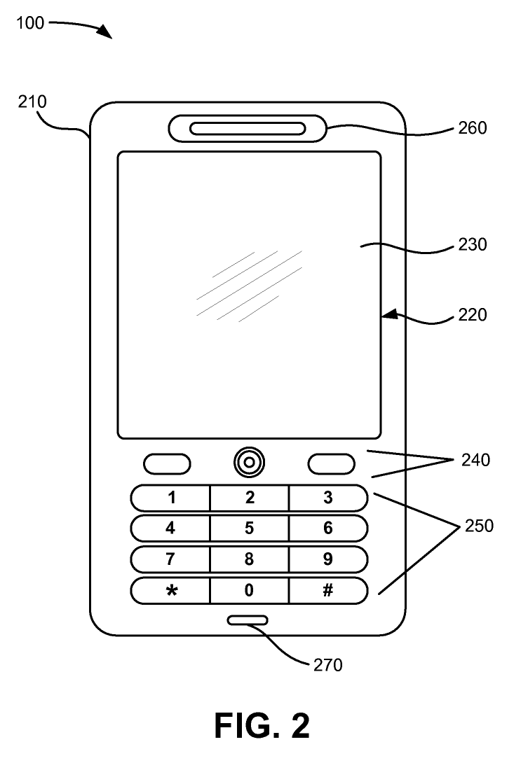

FIG. 2 depicts an exemplary diagram of a user device 100 in which systems and/or methods described herein may be implemented. As illustrated, user device 100 may include a housing 210, a display 220, a touch panel 230, control buttons 240, a keypad 250, a speaker 260, and/or a microphone 270.

Housing 210 may protect the components of user device 100 from outside elements. Housing 210 may include a structure configured to hold devices and components used in user device 100, and may be formed from a variety of materials. For example, housing 210 may be formed from plastic, metal, or a composite, and may be configured to support display 220, control buttons 240, keypad 250, speaker 260, and/or microphone 270.

Display 220 may include a device that can display signals generated by user device 100 as text or images on a screen (e.g., a liquid crystal display (LCD), cathode ray tube (CRT) display, organic light-emitting diode (OLED) display, surface-conduction electro-emitter display (SED), plasma display, field emission display (FED), bistable display, etc.). In certain implementations, display 220 may provide a high-resolution, active-matrix presentation suitable for the wide variety of applications and features associated with mobile devices.

Display 220 may provide visual information to the user and serve—in conjunction with touch panel 230—as a user interface to detect user input. For example, display 220 may provide information and menu controls regarding incoming or outgoing telephone calls and/or incoming or outgoing electronic mail (e-mail), instant messages, short message service (SMS) messages, etc. Display 220 may further display information and controls regarding various applications executed by user device 100, such as a web browser, a phone book/contact list program, a calendar, an organizer application, image manipulation applications, navigation/mapping applications, an MP3 player, as well as other applications. For example, display 220 may present information and images associated with application menus that can be selected using multiple types of input commands. Display 220 may also display images associated with a camera, including pictures or videos taken by the camera and/or received by user device 100. Display 220 may also display video games, downloaded content (e.g., news, images, or other information), etc.

As shown in FIG. 2, touch panel 230 may be integrated with and/or overlaid on display 220 to form a touch screen or a panel-enabled display that may function as a user input interface. For example, in one implementation, touch panel 230 may include near field-sensitive (e.g., capacitive) technology, acoustically-sensitive (e.g., surface acoustic wave) technology, photo-sensitive (e.g., infra-red) technology, pressure-sensitive (e.g., resistive) technology, force-detection technology and/or any other type of touch panel overlay that allows display 220 to be used as an input device.

Generally, touch panel 230 may include any kind of technology that provides the ability to identify multiple touches registered on the surface of touch panel 230. Touch panel 230 may also include the ability to identify movement of a body part or a pointing device as it moves on or near the surface of touch panel 230.

Control buttons 240 may permit the user to interact with user device 100 to cause user device 100 to perform one or more operations. For example, control buttons 240 may be used to cause user device 100 to activate a toolbar (such as toolbar 110 of FIG. 1) or to transmit and/or receive information (e.g., to display a text message via display 220, raise or lower a volume setting for speaker 260, etc.).

Keypad 250 may also be included to provide input to user device 100. Keypad 250 may include a standard telephone keypad. Keys on keypad 250 may perform multiple functions depending upon a particular application selected by the user. In one implementation, each key of keypad 250 may be, for example, a pushbutton. A user may utilize keypad 250 for entering information, such as text or a phone number, or activating a special function. Alternatively, keypad 250 may take the form of a keyboard that may facilitate the entry of alphanumeric text.

Speaker 260 may provide audible information to a user of user device 100. Speaker 260 may be located in an upper portion of user device 100, and may function as an ear piece when a user is engaged in a communication session using user device 100. Speaker 260 may also function as an output device for music and/or audio information associated with games and/or video images played on user device 100.

Microphone 270 may receive audible information from the user. Microphone 270 may include a device that converts speech or other acoustic signals into electrical signals for use by user device 100. Microphone 270 may be located proximate to a lower side of user device 100.

Although FIG. 2 shows exemplary components of user device 100, in other implementations, user device 100 may contain fewer, different, or additional components than depicted in FIG. 2. In still other implementations, one or more components of user device 100 may perform one or more other tasks described as being performed by one or more other components of user device 100.

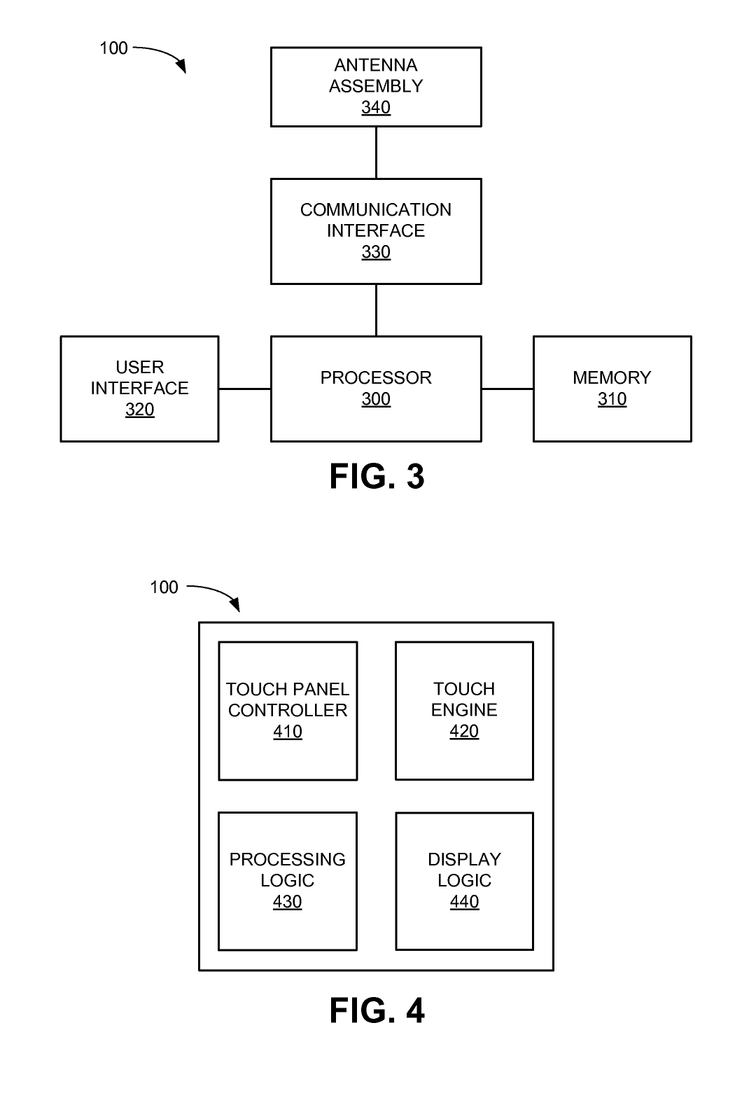

FIG. 3 illustrates a diagram of exemplary components of user device 100. As illustrated, user device 100 may include a processor 300, a memory 310, a user interface 320, a communication interface 330, and/or an antenna assembly 340.

Processor 300 may include a microprocessor, an application-specific integrated circuit (ASIC), a field-programmable gate array (FPGA), or the like. Processor 300 may control operation of user device 100 and its components. In one implementation, processor 300 may control operation of components of user device 100 in a manner described herein.

Memory 310 may include a random access memory (RAM), a read-only memory (ROM), and/or another type of memory to store data and instructions that may be used by processor 300. Memory 310 may be sufficient to enable multiple applications or instances of applications to run simultaneously on user device 100. For example, in one implementation, memory 310 may support the displaying and updating of multiple open application windows.

User interface 320 may include mechanisms for inputting information to user device 100 and/or for outputting information from user device 100. Examples of input and output mechanisms might include buttons (e.g., control buttons 240, keys of keypad 250, a joystick, etc.) or a touch screen interface (e.g., display 220 and touch panel 230) to permit data and control commands to be input into user device 100; a speaker (e.g., speaker 260) to receive electrical signals and output audio signals; a microphone (e.g., microphone 270) to receive audio signals and output electrical signals; a display (e.g., display 220) to output visual information (e.g., text input into user device 100); a vibrator to cause user device 100 to vibrate; and/or a camera to capture video and/or images.

Communication interface 330 may include, for example, a transmitter that may convert baseband signals from processor 300 to radio frequency (RF) signals and/or a receiver that may convert RF signals to baseband signals. Alternatively, communication interface 330 may include a transceiver to perform functions of both a transmitter and a receiver. Communication interface 330 may connect to antenna assembly 340 for transmission and/or reception of the RF signals.

Antenna assembly 340 may include one or more antennas to transmit and/or receive RF signals over the air. Antenna assembly 340 may, for example, receive RF signals from communication interface 330 and transmit them over the air, and receive RF signals over the air and provide them to communication interface 330. In one implementation, for example, communication interface 330 may communicate with a network and/or devices connected to a network.

As will be described in detail below, user device 100 may perform certain operations described herein in response to processor 300 executing software instructions of an application contained in a computer-readable medium, such as memory 310. A computer-readable medium may be defined as a physical or logical memory device. The software instructions may be read into memory 310 from another computer-readable medium or from another device via communication interface 330. The software instructions contained in memory 310 may cause processor 300 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of user device 100, in other implementations, user device 100 may contain fewer, additional, different, or differently arranged components than depicted in FIG. 3. In still other implementations, one or more components of user device 100 may perform one or more other tasks described as being performed by one or more other components of user device 100.

FIG. 4 is a functional block diagram of exemplary functional components that may be included in user device 100. As shown, user device 100 may include a touch panel controller 410, a touch engine 420, processing logic 430, and display logic 440. In other implementations, user device 100 may include fewer, additional, or different types of functional components than those illustrated in FIG. 4.

Touch panel controller 410 may include hardware and/or software to identify touch coordinates from touch panel 230. Coordinates from touch panel controller 410, including the identity of particular sensors in, for example, the X and Y dimensions, may be passed on to touch engine 420 to associate the touch coordinates with, for example, an object displayed on display 220.

Touch engine 420 may include hardware and/or software for processing signals that are received at touch panel controller 410. Touch engine 420 may use the signal received from touch panel controller 410 to associate the touch coordinates with information shown on the display and to determine sequences, locations, and/or time intervals of the touches so as to differentiate between touch inputs. The touch detection, the touch intervals, the sequence, and the touch location may be used to provide a variety of user input to user device 100. For example, touch engine 420 may associate a signal received from touch panel controller 410 with a menu item from a toolbar, such as toolbar 110.

Processing logic 430 may include hardware and/or software to implement changes based on signals from touch engine 420. For example, in response to signals that are received at touch panel controller 410, touch engine 420 may cause processing logic 430 to associate the menu selection based on the touch coordinates with an open application window.

Display logic 440 may include hardware and/or software to alter a display, such as display 220, based on instructions from processing logic 430. For example, when processing logic 430 identifies an open application window associated with a menu selection, display logic 440 may be instructed to show the open application window on the display.

### Exemplary Touch Sequence Patterns

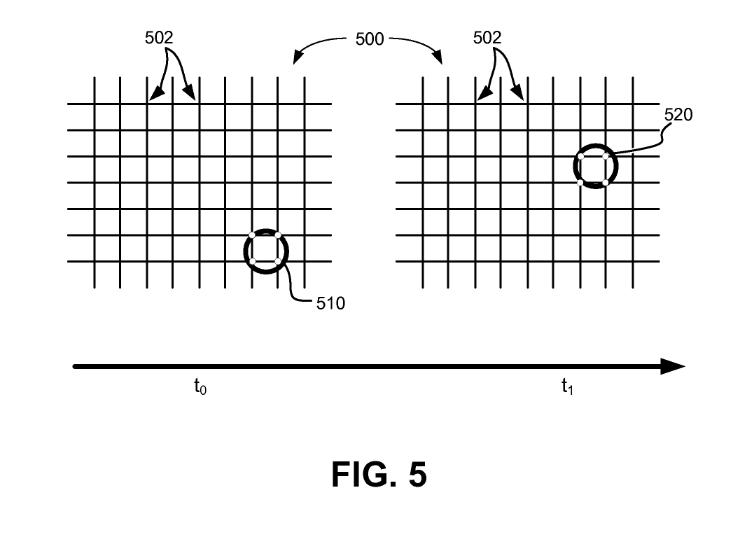

FIG. 5 is a diagram illustrating an exemplary touch sequence pattern on a surface 500 of a touch panel 230 of an exemplary user device. A touch panel 230 may generally include a surface 500 configured to detect a touch at one or more sensing nodes 502. In one implementation, surface 500 may include sensing nodes 502 using a grid arrangement of transparent conductors to track approximate horizontal (e.g., “X”) and vertical (e.g., “Y”) positions, as shown in FIG. 5. In other implementations, other arrangements of sensing nodes 502 may be used, including polar coordinates, parabolic coordinates, etc. The number and configuration of sensing nodes 502 may vary depending on the required accuracy/sensitivity of the touch panel. Generally, more sensing nodes can increase accuracy/sensitivity of the touch panel. A signal may be produced when an object (e.g., a user's finger or a stylus) touches a region of surface 500 over a sensing node 502.

In one implementation, surface 500 may represent a multi-touch sensitive panel or other touch panel capable of registering a sliding touch. Each sensing node 502 may represent a different position on surface 500 of the touch panel, and each sensing node 502 may be capable of generating a signal at the same time. When an object is placed over multiple sensing nodes 502 or when the object is moved between or over multiple sensing nodes 502, multiple signals can be generated. In one implementation, a touch on surface 500 may be tracked as it slides along surface 500 from one location to another. The removal of the touch from surface 500 may be interpreted as a command signal corresponding to the last recognized location of the touch.

Referring to FIG. 5, at time t₀, a finger (or other object) may touch surface 500 in the area denoted by position 510 indicating the general finger position. The touch may be registered at one or more sensing nodes 502 of surface 500, allowing the touch panel to identify coordinates of the touch. In one implementation, the touch coordinates at position 510 may be associated with an object (e.g., a menu item or icon) on a display underlying surface 500. For example, the touch coordinates at position 510 may be associated with a menu item on a toolbar (such as toolbar 110). In another implementation, the touch coordinates may be associated with a display separately located from surface 500.

After time to, in one implementation, the finger may slide along touch surface 500 to eventually stop at position 520 at a time t₁. Between time t₀ and t₁, the touch may be registered at one or more intermediate sensing nodes 502 of surface 500. In another implementation, the touch at position 510 and the touch at position 520 may be separate touches (e.g., the finger may be removed from surface 500 between time t₀ and t₁). The touch coordinates at position 520 may be associated with an object (e.g., a menu item or icon different from that of position 510) on the display underlying surface 500. For example, the touch coordinates at position 520 may be associated with another menu item on a toolbar (such as toolbar 110).

### Exemplary Display Interface

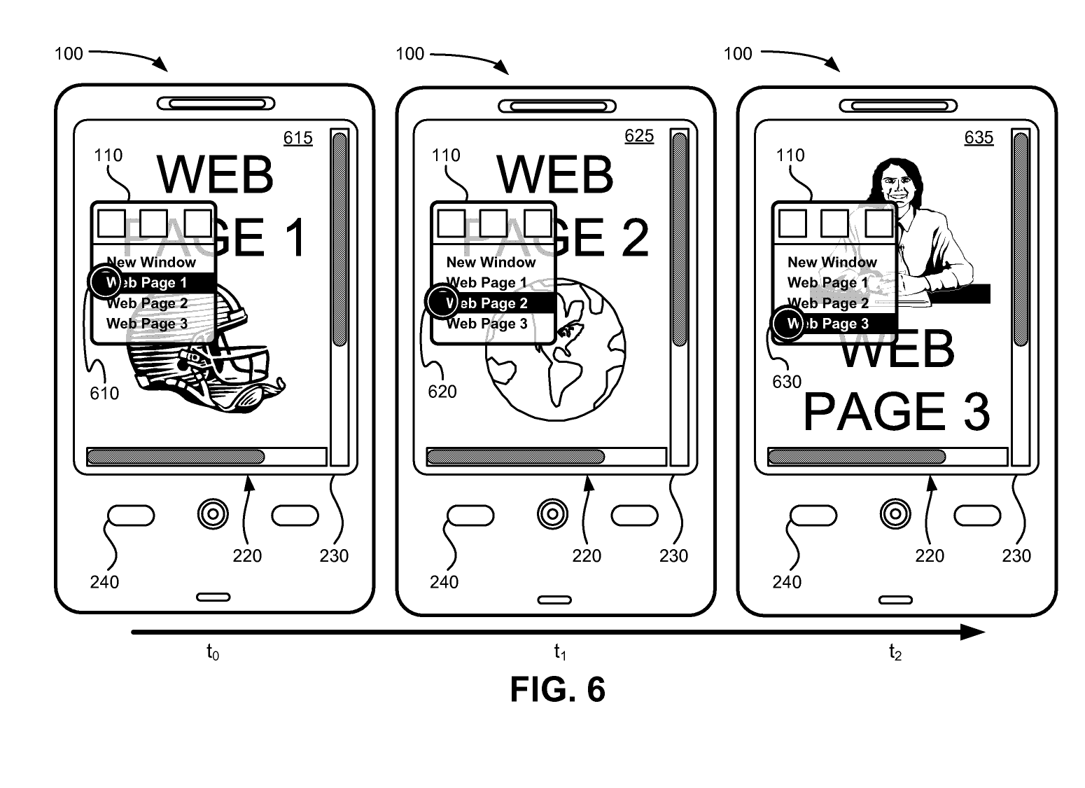

FIG. 6 shows an exemplary touch input on the surface of a display 220 as a function of time according to an exemplary implementation. As shown in FIG. 6, user device 100 may show a toolbar 110 on display 220. User device 100 may activate toolbar 110 in response to a signal initiated by a user. A user may initiate a signal by, for example, pressing one of control buttons 240, touching a “hot corner” of touch panel 230 that is designated to active toolbar 110, dragging an icon from another portion of display 220 (not shown) onto an active window, providing a voice command, or other user input techniques.

User device 100 may include a touch panel 230 to receive user input. At time to, a user may touch a particular location 610 on touch panel 230 that corresponds to a location on toolbar 110 on display 220. The particular location 610 may correspond to, for example, a menu item corresponding to an open application window of interest to the user (i.e., “Web Page 1”). The touch at the location 610 may be interpreted as a command to display an open application window corresponding to the selected menu item. In one implementation, while the user's touch remains at location 610, user device 100 may display in the background (e.g., behind toolbar 110) of display 220 an open application window 615 corresponding to the selected menu item. In another implementation, user device 100 may display the open application window 615 when the touch is removed and until another user input is received.

At time t₁, a user may touch a second location 620 on touch panel 230. In the implementation shown in FIG. 6, the second touch location 620 may correspond to, for example, a menu item corresponding to another open application window of interest to the user (i.e., “Web Page 2”). The touch at the second location 620 may be interpreted as a command. Particularly, the touch at the second location 620 may be interpreted by user device 100 as a command to display an open application window corresponding to the selected menu item “Web Page 2.” Thus, when the user's touch moves from location 610 to location 620, user device 100 may alter the display in the background of display 220 to show open application window 625 corresponding to the selected menu item “Web Page 2.”

At time t₂, a user may touch a third location 630 on touch panel 230. In the implementation shown in FIG. 6, the third touch location 630 may correspond to, for example, a menu item corresponding to different open application window of interest to the user (i.e., “Web Page 3”). The touch at the third location 630 may be interpreted as a command. Particularly, the touch at the third location 630 may be interpreted by user device 100 as a command to display an open application window corresponding to the selected menu item “Web Page 3.” Thus, when the user's touch moves from location 620 to location 630, user device 100 may alter the display in the background of display 220 to show open application window 635 corresponding to the selected menu item “Web Page 3.”

In one implementation, the touches at location 610, 620 and 630 may be accomplished by a user without removing the user's finger from touch panel 230 (e.g., the touch slides from location 610 to location 620 to location 630). Thus, when a user removes a touch from toolbar 110, user device 100 may interpret the removal as a command to stop displaying toolbar 110 and to continue to show the most recently selected open application window. In another implementation, the touches at location 610, 620 and 630 may be accomplished by separate touches (e.g., the user's finger may be removed from the surface of touch panel 230 between touches). Thus, a separate command, such as a double-touch (e.g., two touches in the same location within a particular interval) or a separate press of a command button (such as one of control buttons 240) may be used to stop displaying toolbar 110.

In one implementation, the use of toolbar 110 to provide a live preview of open application windows and to switch between the open application windows may be restricted to open windows within a single application. For example, toolbar 110 may limit menu options to open windows of a web browser application, open windows of a word processing application, open windows of a spreadsheet application, or the like. In another implementation, toolbar 110 may provide a live preview of all (or a subset) of the open application windows of multiple application types. Also, in another implementation, open application windows (such as open application windows 615, 625, and 635) may display full functionality while displayed in the background of display 220 behind toolbar 110. For example, if the open application is a window showing a web page, features such as animations, updates, streaming video, audio, and the like may be presented to the user.

Although FIG. 6 shows exemplary components of user device 100, in other implementations, user device 100 may contain fewer, additional, different, or differently arranged components than depicted in FIG. 6. In still other implementations, one or more components of user device 100 may perform one or more other tasks described as being performed by one or more other components of user device 100.

### Exemplary Process

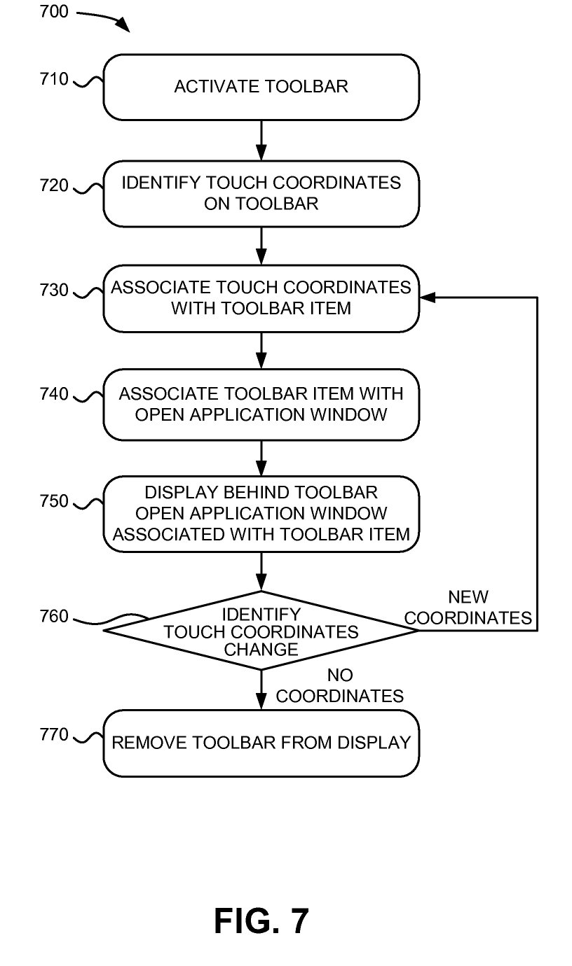

FIG. 7 depicts a flow chart of an exemplary process 700 for operating user device 100 according to implementations described herein. In one implementation, process 700 may be performed by hardware, software, or a combination of hardware and software components of user device 100 (e.g., display 220, touch panel 230, processor 300, etc.). In other implementations, process 700 may be performed by hardware, software, or a combination of hardware and software components of user device 100 in combination with hardware, software, or a combination of hardware and software components of another device (e.g., communicating with user device 100 via communication interface 330).

As illustrated in FIG. 7, process 700 may begin by activating a toolbar (block 710). For example, user device 100 may receive a signal initiated by a user to display a toolbar, such as toolbar 110, on display 220. The signal may be generated, for example, when a user presses a control button (e.g., one of control buttons 240) or provides a voice command to activate the toolbar. The toolbar may be displayed on display 220 as overlaid on a portion of an application window, such as a browser window containing a web page. In one implementation, the size of toolbar may be smaller than the size of the application window, so as to permit viewing of at least a portion of the application window behind the toolbar. In another implementation, some or all of the toolbar may be partially transparent to allow at least a portion of the application window to be viewed through the toolbar. The toolbar may include one or more selections corresponding to open application windows in user device 100.

A set of touch coordinates on the toolbar may be identified (block 720). For example, touch panel controller 410 of user device 100 may identify touch coordinates from a touch on touch panel 230. The touch may be made by a user touching an area on the surface of user device 100 with an object, such as a finger or a stylus.

The set of touch coordinates may be associated with an item on the toolbar (block 730). For example, touch engine 420 of user device 100 may associate the touch coordinates with a menu selection on toolbar 110. The menu selection may include a title, icon, or other indication of an open application window, such as menu selection 112 of FIG. 1.

The toolbar item may be associated with an open application window (block 740). For example, processing logic 430 of user device 100 may associate the menu selection based on the touch coordinates with an open application window.

The open application window associated with the toolbar item may be displayed behind the toolbar (block 750). For example, display logic 440 of user device 100 may display the open application window corresponding to the menu selection. The open application window may be displayed behind the toolbar (e.g., with the toolbar continuing to appear overlaid on the open application window).

A change to the touch coordinates may be identified (block 760). For example, touch panel controller 410 of user device 100 may detect a change in touch coordinates caused by the movement of a finger on the surface of touch panel 230. The movement may represent sliding of the finger to a new position on the surface of touch panel 230 or removal of the finger from touch panel 230. If new touch coordinates are identified on the toolbar (indicating, e.g., a change of location of the touch), process 700 may return to block 730 to associate the new touch coordinates with a new toolbar item. If no touch coordinates are identified on the toolbar (indicating, e.g., removal of a touch), process 700 may proceed to remove the toolbar from the display (block 770). For example, display logic 440 may remove toolbar 110 from view, leaving the most recently displayed open application window available to the user for viewing and/or interaction.

While process 700 is described above primarily in the context of a touch screen interface incorporating sliding touch recognition, in other implementations, systems and/or methods described herein may incorporate other touch interfaces or non-touch interfaces. For example, in one implementation, user input for the toolbar menu may be performed using a single-touch/double-touch paradigm. In another exemplary implementation, user input for the toolbar may be performed using a combination of single-touches and a control button to manipulate the display. In still another exemplary implementation, control buttons may be used to both activate the toolbar and scroll through menu items in the toolbar without the use of a touch interface.

### Exemplary Device

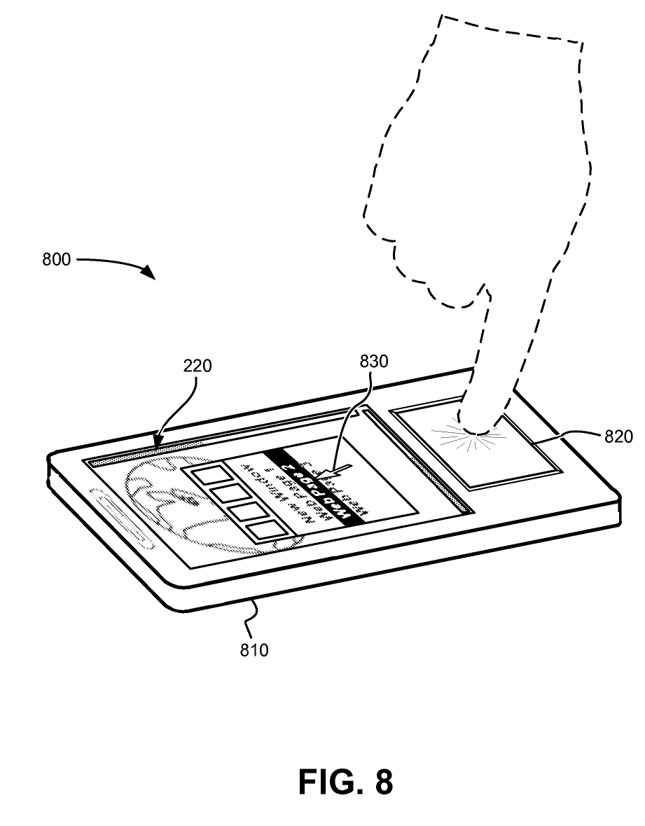

FIG. 8 provides an isometric view of another exemplary user device 800 in which methods and systems described herein may be implemented. User device 800 may include housing 810, display 220, and touch panel 820. Other components, such as control buttons, a keypad, a microphone, a camera, connectivity ports, memory slots, and/or additional speakers, may be located on user device 800, including, for example, on a rear or side panel of housing 810. FIG. 8 illustrates touch panel 820 being separately located from display 220 on housing 810. Touch panel 820 may include any multi-touch touch panel technology or any single-touch touch panel technology. User input on touch panel 820 may be associated with display 220 by, for example, movement and location of a cursor 830. User input on touch panel 820 may be consistent with the underlying touch panel technology (e.g., capacitive, resistive, etc.) so that a touch of nearly any object, such as a body part (e.g., a finger, as shown), a pointing device (e.g., a stylus, pen, etc.), or a combination of devices may be used.

Touch panel 820 may be operatively connected with display 220. For example, touch panel 820 may include a resistive touch panel that allows display 220 to be used in conjunction with touch panel 820 as an input device. Touch panel 820 may include the ability to identify movement of an object as it moves on the surface of touch panel 820. Thus, cursor 830 may be moved over a toolbar to allow a user to see an open application window corresponding to a menu item on the toolbar. Thus, in FIG. 8, a user indication of “Web Page 2” via cursor 830 may trigger user device 800 to display the open application window that corresponds to “Web Page 2.” In some implementation, the toolbar may be removed from display 220 by, for example, a double touch on the selected menu item or by moving cursor 830 off the toolbar display. In other implementations, the toolbar may be removed after a particular time interval or after a particular time period of inactivity on touch panel 820.

Although FIG. 8 shows exemplary components of user device 800, in other implementations, user device 800 may contain fewer, additional, different, or differently arranged components than depicted in FIG. 8. In still other implementations, one or more components of user device 800 may perform one or more other tasks described as being performed by one or more other components of user device 800.

### CONCLUSION

Systems and/or methods described herein may provide a user interface that allows a user to see a live preview of open application windows while selecting from a list of windows. Implementations described herein may provide a toolbar that includes a menu based on open application window indictors. When a user moves a touch or cursor over a menu item, the open application window corresponding to the menu item may be displayed behind the toolbar.

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIG. 7, the order of the blocks may be modified in other implementations. Further, non-dependent blocks may be performed in parallel.

As another example, while implementations have been described primarily in the context a touch interface, other user interface techniques may be used to implement live preview of open application windows. For example, keypad commands or mouse commands may be used to maneuver a cursor though a toolbar display.

It should be emphasized that the term “comprises” and/or “comprising,” when used in the this specification, is taken to specify the presence of stated features, integers, steps or components but does not preclude the presence or addition of one or more other features, integers, steps, components or groups thereof.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method performed by a device having a display and multiple open applications, the method comprising:
displaying a toolbar on a portion of the display, the toolbar including a menu of items, where each item corresponds to an open application window associated with one of the open applications;
receiving selection of one of the items on the menu;
identifying an open application window corresponding to the selected one of the items; and
altering the display to show, behind the toolbar, the identified open application window.

2. The method of claim 1, where receiving the selection includes receiving a touch on a touch panel.

3. The method of claim 2, where receiving the selection comprises:
identifying touch coordinates of the touch on the touch panel; and
associating the touch coordinates with the one of the items on the menu.

4. The method of claim 1, where at least a portion of the toolbar is partially transparent.

5. The method of claim 1, where the toolbar is smaller than a size of the identified open application window.

6. The method of claim 1, further comprising:
receiving selection of another one of the items on the menu;
identifying another open application window associated with a same one of the open applications or a different one of the open applications; and
altering the display to show, behind the toolbar, the other open application window.

7. The method of claim 1, further comprising:
identifying a user selection of one of the items on the menu; and
removing the display of the toolbar from on top of the identified open application in response to the identified user selection.

8. The method of claim 7, where the identifying the user selection comprises:
identifying no touch coordinates corresponding to a touch on the toolbar.

9. The method of claim 1, further comprising:
receiving a signal to activate the toolbar, where the signal is generated by one of:
pressing a control button on the device,
touching a particular location of a touch panel on the device that is designated to activate the toolbar,
dragging an icon from another portion of the display onto an open window, or
providing a voice command.

10. A device, comprising:
a display to present a toolbar and one of multiple open application windows, the toolbar including a list of the multiple open application windows;
a touch panel to identify coordinates of a touch on the touch panel; and
a processor to:
associate the touch coordinates with one of the multiple open application windows on the list,
identify an open application window associated with the one of the multiple open application windows on the list, and
alter the display to show the one of the multiple open application windows behind the toolbar.

11. The device of claim 10, further comprising:
a memory to store data that supports the displaying and updating of the multiple open application windows.

12. The device of claim 10, where at least a portion of the toolbar is partially transparent.

13. The device of claim 10, where the toolbar is smaller than a size of the one of the multiple open application windows.

14. The device of claim 10, where the processor is further configured to:
identify a removal of the touch from the touch panel; and
remove, based on the identified removal, the display of the toolbar from on top of the one of the multiple open application windows.

15. The device of claim 10, where the touch panel is overlaid on the display.

16. The device of claim 10, further comprising:
a housing, where the touch panel and the display are located on separate portions of the housing.

17. The device of claim 10, where the processor is further configured to:
activate displaying of the toolbar based on a touch on a particular location of the touch panel.

18. A device, comprising:
means for displaying a toolbar and one of multiple open application windows, the toolbar including a menu of items, where each of the items corresponds to one of the multiple open application windows;
means for identifying one of the items on the menu;
means for identifying one of the multiple open application windows corresponding to the identified one of the items; and
means for displaying, behind the toolbar, the identified one of the multiple open application windows.

19. The device of claim 18, further comprising:
means for activating displaying of the toolbar, and
means for removing the toolbar.

20. The device of claim 18, further comprising:
means for identifying a different one of the items on the menu;
means for identifying another one of the multiple open application windows corresponding to the different one of the items; and
means for displaying, behind the toolbar, the other one of the multiple open application windows.
